(19) United States
(12) Patent Application Publication
(10) Pub. No.: US 2010/0254641 A1
(43) Pub. Date: Oct. 7, 2010

(54) ROTARY-SLIDE BEARING WITH A CONVEX AND AN ELASTICALLY YIELDING SLIDING SURFACE

(75) Inventor: Stefan Hoppe, Sulz (DE)

Correspondence Address: SCULLY SCOTT MURPHY & PRESSER, PC, 400 GARDEN CITY PLAZA, SUITE 300, GARDEN CITY, NY, 11530, US

(73) Assignee: ROBERT BOSCH GMBH, Stuttgart (DE)

(21) Appl. No.: 12/742,316

(22) PCT Filed: Dec. 5, 2008
(86) PCT No.: PCT/EP2008/010345

§ 371 Date: May 11, 2010

(30) Foreign Application Priority Data
Dec. 13, 2007 (DE) 10 2007 060 014.5

(51) Int. Cl. F16C 33/04

(52) U.S. Cl. 384/125

(57) ABSTRACT

The invention relates to a rotary slide bearing (25a), especially for an output shaft (19) of an axial piston engine (1), comprising an inner rotary bearing part and an outer rotary bearing part (31, 32) having coaxially arranged sleeve-type sliding surfaces (31a, 32a) and mounted in such a way that they can be relatively rotated and slide over each other. In order to improve the rotary slide bearing (25c), the sliding surface (31a) of one (31) of the rotary bearing parts has an axially convex embodiment (31b), and the other rotary bearing part (32) has an elastic embodiment (32b) radially opposing the convex embodiment (32b).

The invention relates to a rotary-slide bearing according to the preamble of claim 1.

A rotary-slide bearing of this type is described in DE 102 20 610 A1. This previously known rotary-slide bearing comprises three sleeve-typed bearing parts surrounding one another in a coaxial manner, wherein the innermost and the central bearing part are borne on one another with hollow cylindrical sliding surfaces, and the central and the outer bearing part are borne on one another with spherical bearing surfaces, which guarantee an oscillating movement between these bearing parts.

In order to fit a rotary-slide bearing of this kind through a relative axial displacement between the central bearing part and the outer bearing part, the outer bearing part provides in its concave bearing surface two insertion grooves disposed opposite to one another, in which the central bearing part can be introduced in a position rotated through 90° and can be rotated back in the final insertion position into a coaxial position. This previously known rotary-slide bearing therefore not only provides a multiplicity of components, but it is also complex in production and is therefore costly to manufacture. Moreover, the rotary-slide bearing is of a considerable structural size, because at least three bearing parts disposed one inside the other are required. The invention is based upon the object of simplifying a rotary-slide bearing specified in introduction. Moreover, a small structural size should be achieved, and the slide bearing should also be improved.

The object is achieved by a rotary-slide bearing with the features of claim 1. The dependent claims contain advantageous further developments.

With the rotary-slide bearing according to the invention, the sliding surface of the one rotary bearing part provides an axially convex form, wherein the other rotary bearing part provides, at least in the axially central region of its sliding surface, an elastically yielding form. As a result, the rotary-slide bearing according to the invention is suitable according to a first aspect to permit and to compensate oscillating movements and/or alignment errors and/or flexing of the drive shaft, without the need, as in the case of the prior art, for a third rotary bearing part. This is possible, because the axially convex form of the sliding surface of the one rotary bearing part creates an all-round degree of freedom of oscillation for the drive shaft, which is determined by the size of the curvature of the convex form. The larger the radius of curvature is, the smaller the angle of the degree of freedom of oscillation will be, and the smaller the radius of curvature of the convex form is, the larger the angle of the degree of freedom of oscillation will be.

A second advantageous aspect of the invention results from the following: the functional security, especially of heavy-duty hydrodynamic sliding bearings, depends to a considerable extent upon the formation of a lubrication gap with approximately constant gap height over the width of the bearing. Angular deviations resulting from flexing of the shaft and/or alignment errors reduce the bearing capacity of the rotary-slide bearing to a considerable extent, because the gap height is in fact not constant, but wedge-shaped, and accordingly, the bearing capacity is impaired.

With the embodiment according to the invention, the gap height is automatically adapted to the size of the radial load, wherein, dependent upon the size of this load, the elastic form yields further, and the axial width of the effective sliding bearing surfaces results automatically. With a relatively smaller load, the axial dimension of the elastically compressed sliding surface region is relatively small. With an increasing load, this axial sliding surface region is automatically enlarged because of the elastic compression. Accordingly, a substantially load-independent surface compression results, wherein the axial dimension of the respectively effective sliding surface region results in each case dependent upon the size of the load, in that the axially convex form is pressed into the elastically yielding form.

Accordingly, the rotary-slide bearing according to the invention achieves a larger bearing capacity or respectively loading capacity, wherein the inner bearing part can perform oscillating movements and can therefore adapt to alignment errors of the drive-shaft bearing and/or flexing of the drive shaft.

For reasons relating to bearing technology, it is advantageous to provide the elastically yielding form in the region of the other rotary bearing part, especially in its axially central bearing surface region. Furthermore, in this context, it is advantageous to provide the axially convex form on the internal bearing part.

Within the framework of the invention, different embodiments are possible, in order to realise the elastically yielding form. One of these possibilities is to form the relevant rotary bearing part at least in its central region in an elastically deformable manner. In this context, the relevant region can be elastically compressible or elastically flexible. The compressibility can be achieved, for example, in that the relevant region is mechanically weakened, for example, through one or more material removals, which can involve, for example, one or more perforations, for example, boreholes, or one or more grooves, which are preferably closed at the slide-bearing surface.

In the case of axial piston engines, the loading of the rotary-slide bearing on its periphery is different, because, in the region of the compression stroke of the piston extending over approximately 180°, the loading is large, and is small in the region of the vacuum stroke of the piston also extending over approximately 180°. Within the framework of the invention, it is therefore advantageous to realise the embodiment according to the invention at least in the region of the compression stroke of the piston, wherein it can also be present in the region of the return stroke, but need not be present. Through a different formation of the embodiment according to the invention in the region of the compression stroke and in the region of the vacuum stroke, the sliding bearing embodiment can be adapted to the anticipated loads. If the embodiment according to the invention is disposed only in the compression-stroke region of the piston, a further simplified embodiment can be achieved, because the rotary-slide bearing can be formed in the region of the vacuum stroke of the piston without the embodiment according to the invention, for example, in the shape of a cylindrical section.

Advantageous embodiments of the invention are explained in greater detail below with reference to exemplary embodiments and drawings.

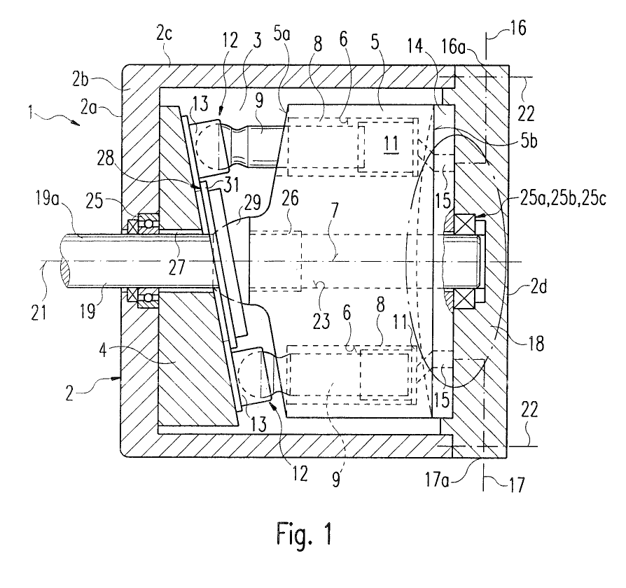

FIG. 1 shows a piston engine, especially an axial piston engine, according to the invention, in an axial section and in a schematic presentation;

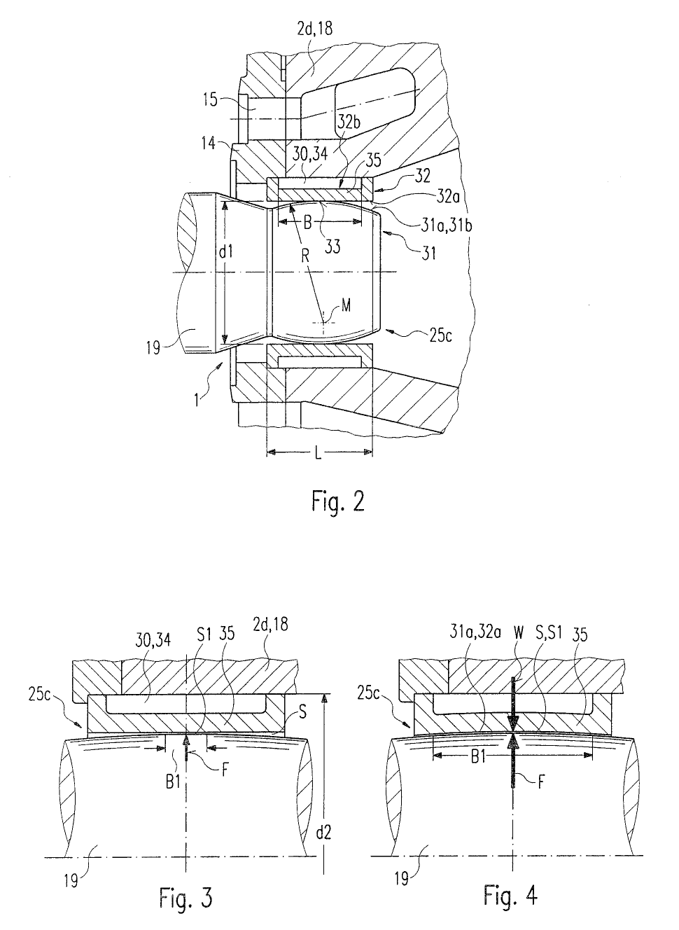

FIG. 2 shows a rotary bearing of the piston engine in an axial section and in an enlarged presentation;

FIG. 3 shows a section of the rotary bearing according to FIG. 2 in an enlarged presentation;

FIG. 4 shows the rotary bearing according to FIG. 3 in the radially loaded condition;

FIG. 5 shows an external rotary bearing part according to the invention in a modified design in a perspective and partially sectional arrangement;

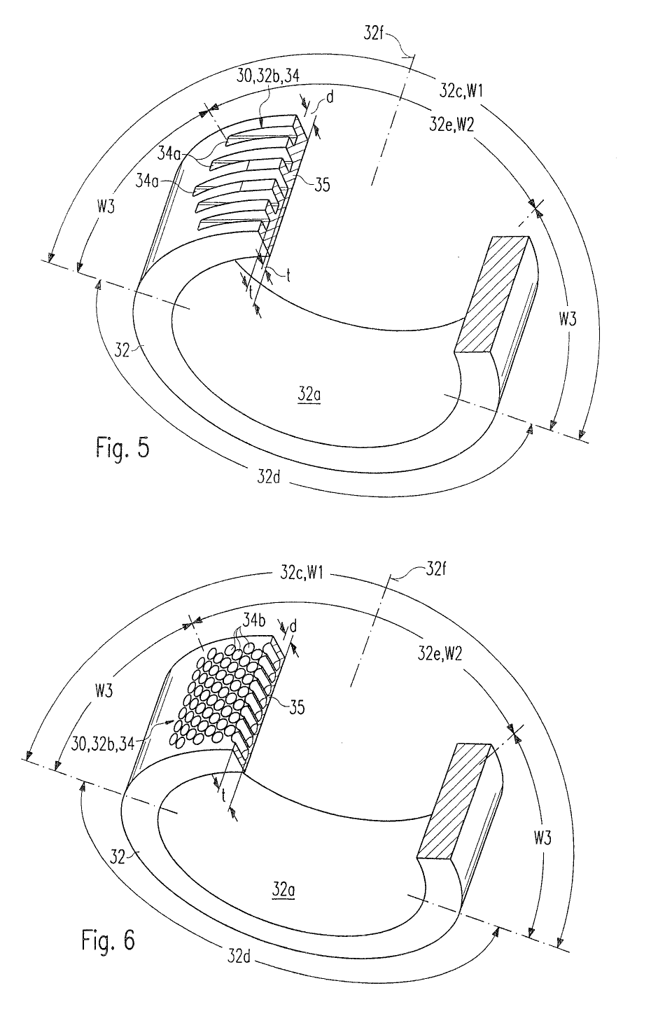

FIG. 6 shows the rotary bearing part according to FIG. 5 in a further modified embodiment;

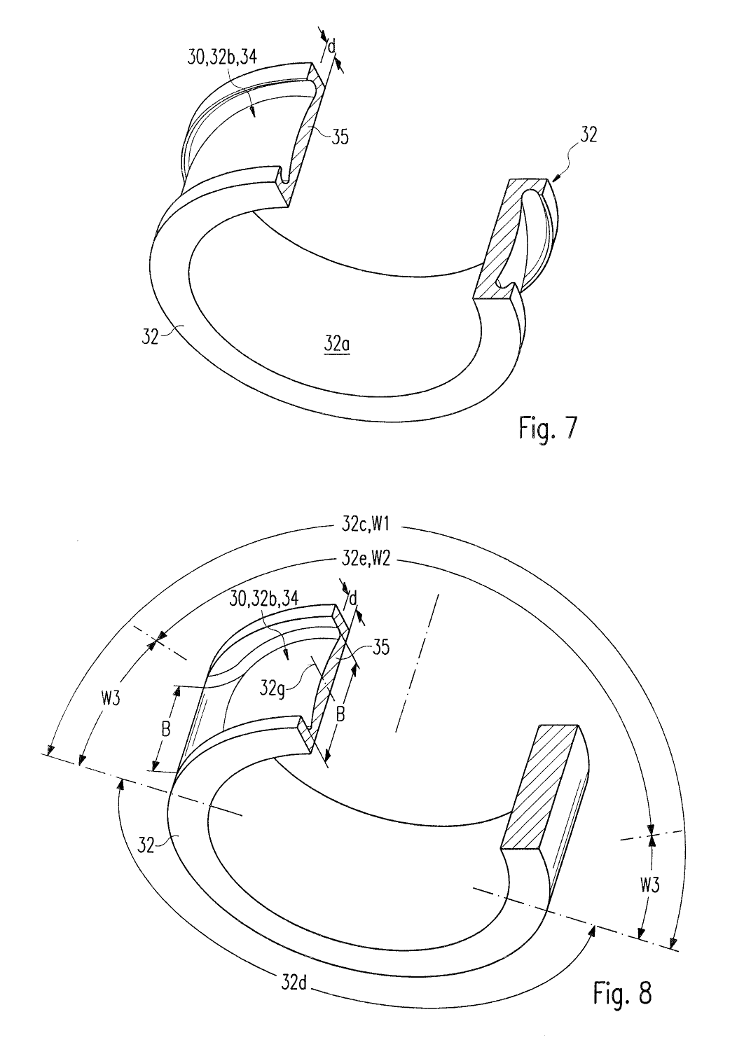

FIG. 7 shows an external rotary bearing part in a further modified embodiment;

FIG. 8 shows an external rotary bearing part in a further modified embodiment.

The axial piston engine presented in FIG. 1 formed in an exemplary manner and referred to as a whole by reference number 1 provides a housing 2, in the internal space 3 of which a driving disk 4, for example, in the form of a swash plate, and a cylindrical drum 5 are arranged and mounted side-by-side. Within the cylindrical drum 5 distributed around the periphery, piston boreholes 6 are arranged, which extend substantially parallel to a central axis 7 of the cylindrical drum 5 and are open at the end face 5a of the cylindrical drum 5 facing towards the driving disk 4. Guide bushes 8 are firmly inserted, preferably pressed into the piston boreholes 6.

Preferably cylindrical pistons 9, which, with their piston heads, limit operating chambers 11 in the cylindrical drum 5 in the direction of the driving disk 4, are mounted in a substantially axially displaceable manner within the guide bushes 8. The lower ends of the pistons 9 facing towards the driving disk 4 are each supported by an articulated joint 12 against the driving disk 4, wherein sliding blocks 13 can be present, between which and the lower ends the articulated joints 12, preferably formed as ball joints with a ball head and a ball recess, are arranged.

The cylindrical drum 5 is disposed with its end face facing away from the swash plate 4 against a control disk 14, in which at least two control apertures 15 in the form of kidney-shaped through perforations are arranged, which form portions of an input line 16 illustrated in outline and an output line 17, which extend through an adjacent housing wall 18, on which the control disk 14 is held. The cylindrical drum 5 is arranged on a drive shaft 19, which is mounted in a rotatable manner within the housing 2 and of which the rotary axis 21 extends coaxially to the central axis 7 of the cylindrical drum 5.

With the present exemplary embodiment, the housing 2 is formed from a pot-shaped housing part 2a with a housing base 2b and a peripheral wall 2c and a cover or connecting part 2d forming the housing wall 18, which is in contact with the free edge of the peripheral wall 2c and is accordingly screw-connected by screws 22 illustrated in outline. In order to connect the further input and output lines 16, 17, line connections 16a, 17a are provided on the connection part 2d. The drive shaft 19, which penetrates the cylindrical drum 5 in a bearing borehole, is mounted in a rotatable manner and sealed in bearing recesses of the housing base 2b and of the cover 2d by means of appropriate rotary bearings 25, 25a, wherein it penetrates the housing base 2b axially and projects from the housing base 2b with a driving pin 19a.

In the exemplary embodiment of the piston engine 1 as a swash-plate engine, the cylindrical drum 5 is arranged via a rotary drive-type fastening 26, for example, a geared coupling, in a rotationally rigid manner on the drive shaft 19, wherein the latter penetrates the driving disk 4 arranged, for example, rigidly on the housing base 2 or formed therein in a through perforation 27. With the present exemplary embodiment, during functional operation, the cylindrical drum 5 rotates relative to the driving disk 4, wherein the pistons 9 are displaced longitudinally in the direction of the operating chambers 11 and back.

In the case of the exemplary embodiment, the rear rotary bearing 25a mounted in the housing wall 18 or in the connecting part 2d is a rotary-slide bearing 25b, which is formed as an oscillating rotary-slide bearing 25c, so that it is in a position to bear the drive shaft 19 in a rotatable manner and moreover to compensate defects in the alignment of the bearings 25, 25a and/or flexing of the drive shaft 19, which occur during functional operation. As a result, jamming in the rotary-slide bearing 25c is avoided or reduced, which improves the sliding function, reduces friction and heating in the rotary-slide bearing 25c and increases the operating life. Within the framework of the invention, the rotary-slide bearing 25b and/or the rotary-slide bearing 25a can be formed as an oscillating rotary-slide bearing 25c according to the invention.

The oscillating rotary-slide bearing 25c according to the invention provides two rotary bearing parts 31, 32 arranged coaxially one within the other, namely the inner rotary bearing part 31 and the outer rotary bearing part 32, which are mounted in a sliding and rotary manner relative to one another with the sleeve-typed sliding surfaces 31a, 32a. The sliding surface of the one rotary bearing part, in the exemplary embodiment, the sliding surface 31a of the inner rotary bearing part 31, provides a convex form 31b, which extends approximately over the axial length L of the rotary-slide bearing 25c or can extend beyond the latter or be shorter. In this context, this slide bearing surface 31a can be a part of the casing surface of the drive shaft 19 or it can also be on a sleeve (not illustrated) seated in a rotationally rigid manner on the drive shaft. The curved shape of the convex form 31b can be, for example, a section of a circular arc, of which the radius is marked R and of which the centre of curvature is marked M. The diameter of the convex sliding surface 31a is marked in the region of the apex 33 of the convex form 31b with d1.

The other rotary bearing part 32, in the exemplary embodiment, the outer rotary bearing part 32, provides an internal diameter d2, which, taking into consideration a slight motional play corresponds to the outer diameter d1.

The other rotary bearing part 32 provides an elastically yielding form 32b disposed radially opposite to the apex 33, which, upon the occurrence of a radial loading or force F, yields in an elastic manner, so that a convex form 31b can move radially, in the exemplary embodiment, radially outwards, and can elastically compress the sleeve-typed sliding surface 31a, as shown in FIG. 4, wherein, by way of example, an approximately maximal loading and force F are illustrated. In this context, the elastically yielding form 32b can extend axially only over one axial part of the length L of the rotary-slide bearing 25c or over the entire region of the length L.

The elastically yielding form 32b can be realised in a different way. It can be formed through a weakening 30 of the peripheral wall of the respective rotary bearing part 32, for example, through a weakening 30 extending in its central region B. This is formed in the case of the exemplary embodiments by one or more external recesses 34 in the rotary bearing part 32, which produce a tapering or weakened peripheral wall 35 surrounding the convex form 31b, which, subject to the action of the loading or force F, is elastically deformed, for example, flexed. In this context, because of the elastic compression, a respectively effective axial sliding surface region B1, in which the gap height S1 of the lubricating gap S is substantially constant, is obtained automatically. In the case of the illustration of FIG. 4, the loading F is relatively large, for example, maximal, wherein the elastic compression extends axially over the entire width B of the elastically yielding form 32b or of the elastically flexible wall 35. By contrast, the axial region B1 is relatively narrow in the case of a small loading or force F, as illustrated by FIG. 3. With an increasing loading or force F, the region B1, in which the sliding surfaces 31a, 32a are effective, becomes wider, and in fact, because of the elastic compression occurring, which is adjusted as a counterweight to the force F and the elastic resistance W, which opposes the elastically yielding form 32b of the force F.

In the case of the exemplary embodiment according to FIG. 5, the weakening 30 or elastically yielding form 32b is formed by several recesses 34 arranged side-by-side in the form of grooves 34a, which extend preferably in the peripheral direction, for example, in the peripheral region 32e.

By way of difference from the above, in the case of the exemplary embodiment according to FIG. 6, several perforations 34b are arranged axially and disposed side-by-side in the peripheral direction. The depth t of the recesses 34, 34a, 34b ends at a radial spacing distance from the sliding surface 32a.

For reasons of simplicity, it is advantageous to arrange the recess 34 around the entire periphery, for example, as an annular recess.

However, in the case of an axial piston engine 1, the pistons 9 exert a pressure, for example, a high pressure primarily during the compression stroke on the one semicircular part of the driving disk 4 over an angular range W1 of 180° and accordingly an enlarged loading in the sense of the force F on the respective rotary-slide bearing 25a, 25b, 25c. A peripheral region 32e providing an elastically yielding form 32b, which can extend within an angular range W2 of the same size or smaller than the compression-peripheral region 32c is disposed at least within this compression-peripheral region 32c illustrated in FIGS. 5, 6 and 8. In this context, the peripheral region 32e can be disposed in the central region of the peripheral region 32c and can provide in each case an angular spacing distance W3 directed in the peripheral direction from the end of the peripheral region 32c.

On the diametrically opposed side, a vacuum-peripheral region 32d adjoins the compression-peripheral region 32c. Within the peripheral region 32d, the pistons 9 perform a vacuum stroke, within the region of which the pistons 9 can, dependent upon the design of the axial piston engine 1, exert a torque opposed to the compression side on the drive shaft 19, which can optionally enlarge the loading or force F acting on the drive shaft 19. Within this vacuum-stroke region, because of the available vacuum pressure, the torque exerted by the pistons 9 on the drive shaft 19 is small or negligibly small, so that the elastically yielding form 32b according to the invention within the vacuum-stroke region or within the peripheral region 32d can be formed with reduced effect or can be completely absent.

This reduced or absent effect can be achieved, for example, in that the weakening 30 is reduced and the elastically yielding form 32b has a larger resistance moment W than the elastically yielding form 32b in the compression-peripheral region 32c. The relatively larger resistance moment W can be achieved, for example, in that the width B in the vacuum-peripheral region 32d is smaller than in the compression-peripheral region 32c, see FIG. 8.

Since the bearing loading or the force F is greatest in the central region 32f of the compression-peripheral region 32c and declines towards the ends of the compression-peripheral region 32c orientated in the peripheral direction, it is advantageous to allow the resistance moment of the elastically yielding form 32b to become larger towards the ends of the compression-peripheral region 32c. With such an embodiment, the axial width B1 of the elastically yielding compression of a convex form 31b is reduced into the elastically yielding form 32b in its end regions W1. This is advantageous, because, starting from the central region 32f, the loading or force F is reduced in both peripheral directions.

A relatively smaller resistance moment of the elastically yielding form 32d can be achieved not only through a reduced width of the recess 34, but also through an increased thickness d of the peripheral wall 35. That is to say, in order to increase the resistance moment W, the axial width of the recess 34 can taper and/or the thickness d of peripheral wall 35 can increase, preferably in each case approximately continuously.

Accordingly, within the framework of the invention, the increasing resistance moment W of the elastically yielding form 32b can advantageously be realised both in the end regions of the compression-peripheral region 32c and also in the region of the vacuum-peripheral region 32d.

Furthermore, it is advantageous to form the elastically yielding form 32b in such a manner that its resistance moment W increases or decreases towards its axial ends, starting from the axially central region 32g of the slide bearing part 32. In the exemplary embodiment according to FIGS. 7 and 8, the latter can be achieved, for example, in that the peripheral wall 35 is formed to converge, for example, in a convex manner, from its central region 32g towards its axial end regions.

With the exemplary embodiment according to FIG. 5, an embodiment is provided, in which the resistance moment W increases starting from the central region 32g towards the axial ends of the peripheral wall 35. With this exemplary embodiment, this is achieved in that the depth of the grooves 34a is reduced towards the axial ends and accordingly, the effective thickness d of the peripheral wall 35 is enlarged.

Accordingly, within the framework of the invention, it is possible to provide a peripheral wall 35 adapted with regard to its width B and/or the thickness d to the size of the loading or force F, which, in the compression-peripheral region 32c or over the entire periphery, is adapted with regard to its width and/or thickness to the bearing loading. This can be achieved in that the effective cross-sectional shape of the peripheral wall 35 is formed in such a manner that, subject to the loading or force F, an elastically yielding deformation is automatically adjusted, in the region of which the gap height S1 is substantially identical.

In all of the exemplary embodiments, at least one recess 34 is closed towards the sliding surface 32a of the associated rotary bearing part 32, so that the surface compression of the respective sliding surface 31a is desirably small.

A material with a sufficient elasticity, which is enlarged in the region of the elastically yielding form 32b, is suitable as the material for the rotary bearing part 32 or the elastically yielding form 32b. For this purpose, an impact-resistant synthetic material is particularly suitable.

In conclusion, the following features and advantages of the invention are emphasised.

Through the axially convex form 32b of the sliding surface 32a of the one bearing part 32, the desired angular compensation in the case of an alignment error or a flexing of the drive shaft 19 can be achieved automatically, wherein a lubricating gap S of approximately constant gap height S1 is adjusted over the elastically formed bearing width B. For this purpose, the elastically yielding region 32b of the relevant bearing part 32 can be formed to be uniform, on the one hand, axially, at least in its central region, and, on the other hand, on its periphery. Because of the different operating pressure and vacuum pressure on the compression side and the vacuum side of the axial piston engine, the elastically yielding form 32b can, however, also be formed to be different in such a manner that its elastic resistance W increases starting from the compression side 32c to the vacuum side 32e or also in the end regions W3 of the compression side 32c.

The invention is not restricted to the exemplary embodiments presented. All of the features described and/or illustrated can be combined within the framework of the invention. For example, other possibilities for forming the bearing ring in an elastically yielding manner, for example, the formation of special hollow cavities or the use of a porous material, are also suitable.

1. A rotary-slide bearing, especially for a drive shaft of an axial piston engine, with an inner and an outer rotary bearing part, which, with sleeve-typed sliding surfaces disposed coaxially relative to one another, are mounted in a rotatable and sliding manner relative to one another, wherein
the sliding surface of the one rotary bearing part provides an axially convex form, and the other rotary bearing part disposed radially opposite to the convex form provides an elastically yielding form.

2. The rotary-slide bearing according to claim 1, wherein
the convex form is disposed on the outer sliding surface of the inner rotary bearing part, and the elastically yielding form is disposed on the inner sliding surface of the outer rotary bearing part.

3. The rotary-slide bearing according to claim 1, wherein
the convex form is formed in one piece on the rotary bearing part embodying it, especially on the inner rotary bearing part, preferably on the drive shaft.

4. The rotary-slide bearing according to claim 1, wherein
the elastically yielding form is formed in one piece on the rotary bearing part embodying it, especially on the inner sliding surface of the outer rotary bearing part, preferably on a bearing sleeve.

5. The rotary-slide bearing according to claim 1, wherein
the axially convex form is approximately equal in length to or longer than the elastically yielding form and is preferably disposed in the axially central region of the elastically yielding form.

6. The rotary-slide bearing according to claim 1, wherein
the axial length (B) of the elastically yielding form is approximately equal in length to or shorter than the axial length (L) of the rotary bearing part embodying it.

7. The rotary-slide bearing according to claim 1, wherein
the elastically yielding form is formed by an elastically deformable portion of the rotary bearing part embodying it.

8. The rotary-slide bearing according to claim 7, wherein
the elastically yielding portion is formed in a radially elastically compressible or elastically flexible manner, especially through an elastically flexible peripheral wall.

9. The rotary-slide bearing according to claim 7, wherein
the elastically yielding form is formed by a material weakening of the rotary bearing part embodying it.

10. The rotary-slide bearing according to claim 9, wherein
the material weakening is formed by one or more recesses disposed adjacent to one another.

11. The rotary-slide bearing according to claim 10, wherein
the material weakening is formed by one or more grooves disposed adjacent to one another, which preferably extends or extend in the peripheral direction.

12. The rotary-slide bearing according to claim 9, wherein
the material weakening is formed by several radial perforations disposed adjacent to one another.

13. The rotary-slide bearing according to claim 10, wherein
the at least one recess is closed towards the sliding surface of the associated rotary bearing part.

14. The rotary-slide bearing according to claim 1, wherein
the elastically yielding form is disposed in the compression-peripheral region or also in the vacuum-peripheral region of the axial piston engine.

15. The rotary-slide bearing according to claim 14, wherein
the elastically yielding form is disposed within an angular region (W) of the compression-peripheral region, which is approximately 90° to approximately 180°, by preference approximately 150°.

16. The rotary-slide bearing according to claim 14, wherein
the resistance (W) of the elastically yielding form on the vacuum side of the axial piston engine is greater than on the compression side.

17. The rotary slide bearing according to claim 16, wherein
the resistance (W) of the elastically yielding form in the end regions (W3) of the compression side is larger than in the central region of the compression side.
